(19) United States
(12) Patent Application Publication
(10) Pub. No.: US 2012/0159623 A1
(43) Pub. Date: Jun. 21, 2012

(54) METHOD AND APPARATUS FOR MONITORING AND PROCESSING DNS QUERY TRAFFIC

(75) Inventor: Yang-Seo CHOI, Daejeon (KR)

(73) Assignee: Electronics and Telecommunications Research Institute, Daejeon (KR)

(21) Appl. No.: 13/325,981

(22) Filed: Dec. 14, 2011

(30) Foreign Application Priority Data
Dec. 17, 2010 (KR) 10-2010-0130306

(51) Int. Cl. G06F 21/20; G06F 15/16

(52) U.S. Cl. 726/22

(57) ABSTRACT

A method for monitoring and processing domain name system (DNS) query traffic includes: monitoring DNS query traffic in each time slot during a monitoring period comprised of n number of time slots; extracting traffic information during the monitoring period by using the DNS query traffic monitored in said each time slot; and analyzing the extracted traffic information to detect a DNS traffic flooding attack.

### CROSS-REFERENCE(S) TO RELATED APPLICATION(S)

The present invention claims priority of Korean Patent Application No. 10-2010-0130306, filed on Dec. 17, 2010, which is incorporated herein by reference.

### FIELD OF THE INVENTION

The present invention relates to a technique for detecting a domain name system (DNS) flooding attack, and more particularly, to a method and apparatus for monitoring and processing DNS query traffic, capable of detecting a DNS flooding attack by modeling types of DNS traffic and behaviors of DNS protocols in normal and attacking situations.

### BACKGROUND OF THE INVENTION

A conventional DNS flooding attack detection technique is focused on the use of the type of detecting an attack on a network layer, rather than a detection technique with respect to an attack on an application layer. Namely, a majority of DNS flooding attack detection techniques so far relate to methods of determining that there is an attack when a larger amount of traffic than the amount of traffic generated in a normal situation based on the overall amount of generated traffic is suddenly generated. In this case, as the reference for determining the amount of traffic, an intuitively applied threshold value or statistics data of traffic may be simply used. Namely, it is determined whether or not an attack is made based on the comparison to the amount of traffic already defined before the detection of the attack.

Such type of an attack detection scheme is very inappropriate to detect an attack on an application layer such as DNS flooding. The reason is because the amount of traffic of a distributed denial of service (DDoS) attack on the application layer is not so much to exceed the normal range, and the amount of traffic generated in a normal situation may be similar as that in an attack situation. For example, in case of DNS query traffic, queries may be suddenly congested to a particular site at a particular time. This situation can occur when the particular site starts to receive applications from the particular time or when the particular site opens a particular event at the particular time. Also, a local DNS has an amount of DNS query traffic which is not so much compared to the amount of normal traffic, but since such queries are generated from multiple local DNSs, a root DNS may have a big problem.

### SUMMARY OF THE INVENTION

In view of the above, the present invention provides a method and apparatus for monitoring and processing DNS query traffic, which is capable of determining whether or not an attack is being made by comparing generated traffic to a normal traffic model in a state of having a list of normal IP addresses used within a management area, whereby an attack can be detected although the amount of attack traffic is not so much compared with the amount of general traffic of a normal situation and whereby an attack is not determined although the amount of normal DNS query traffic is greater than a predefined amount of traffic, thus detecting only attack traffic transferred from pertinent attackers as an attack to thereby protect traffic of normal users and secure continuity of a service.

In accordance with an aspect of the present invention, there is provided a method for monitoring and processing domain name system (DNS) query traffic, the method including:

monitoring DNS query traffic in each time slot during a monitoring period comprised of n number of time slots;

extracting traffic information during the monitoring period by using the DNS query traffic monitored in said each time slot; and

analyzing the extracted traffic information to detect a DNS traffic flooding attack.

In accordance with another aspect of the present invention, there is provided an apparatus for monitoring and processing domain name system (DNS) query traffic, the apparatus including:

an information processing thread for monitoring DNS queries during a monitoring period comprised of multiple time slots to collect information;

a time thread for informing that the monitoring period has terminated;

a traffic determination thread for determining whether or not DNS query traffic is attack traffic based on the information collected by the information processing thread when the monitoring period has terminated; and

an attack protection thread for blocking the attack traffic determined by the traffic determination thread.

### BRIEF DESCRIPTION OF THE DRAWINGS

The objects and features of the present invention will become apparent from the following description of embodiments, given in conjunction with the accompanying drawings, in which:

FIG. 1 is a view illustrating operation process of a DNS protocol to which an apparatus for monitoring and processing DNS query traffic in accordance with an embodiment of the present invention is applied;

FIG. 2 is a view illustrating a DNS flooding attack;

FIG. 3 is a block diagram illustrating the apparatus for monitoring and processing DNS query traffic in accordance with the embodiment of the present invention;

FIG. 4 is a view showing a structure of a monitoring period set in an information processing thread in accordance with the embodiment of the present invention;

FIG. 5 is a flowchart illustrating the process of collecting information for traffic modeling in accordance with the embodiment of the present invention; and

FIG. 6 is a flowchart illustrating the operation process of the apparatus for monitoring and processing DNS query traffic in accordance with the embodiment of the present invention.

### DETAILED DESCRIPTION OF THE EMBODIMENTS

First of all, an operating method of a domain name system (DNS) protocol will be briefly described, before explaining a traffic modeling apparatus and method in accordance with embodiments of the present invention.

According to a general DNS protocol, when a user wants to obtain an address of a particular uniform resource locator (URL), first, a DNS query for a desired URL is sent to a local DNS used by the user.

Then, the local DNS searches its database for an internet protocol (IP) address of the desired URL. When the IP address does not exist in the database, the local DNS sends to the root DNS a request requiring a check of the corresponding address. Then, the root DNS transmits to the local DNS an address of a server managing the last area of the address requested to be checked. This process is performed recursively until a final. IP address is obtained.

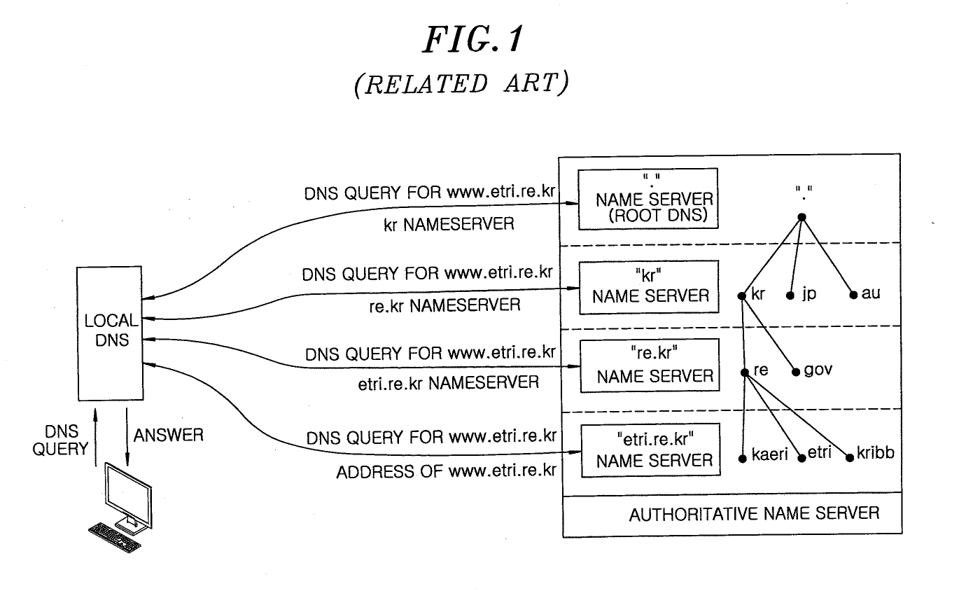

An example of such operating method of the DNS protocol is shown in FIG. 1, which illustrates a schematized process of checking an address of URL of “www.etri.re.kr”.

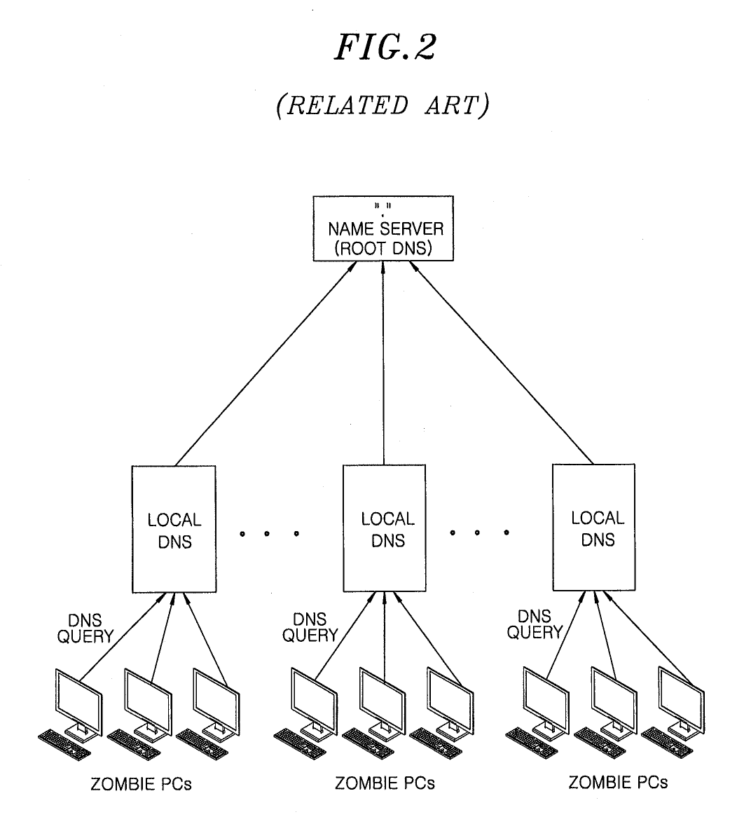

Next, a DNS flooding attack to be applied to the embodiments of the present invention will be described with reference to FIG. 2.

As shown in FIG. 2, as for the DNS flooding attack against a DNS protocol operating as described above, zombie personal computers (PCs) controlled by an attacker transmit a large amount of DNS queries to a local DNS server provided in a network to which they belong, and the local DNS also transmits a large amount of additional DNS queries to a root DNS in order to check the DNS queries received from the zombie PCs. Accordingly, a large amount of attack traffic reaches the root DNS, so that the DNS flooding attack is performed on the root DNS. Here, although the amount of DNS queries transmitted to the local DNSs from the zombie PCs is not great in a single particular network, the attack traffic delivered to the root DNS may be very large if the DNS queries are requested in a plurality of networks.

In the analysis, for detecting such attack, of the DNS query traffic requested from the zombie PCs to the local DNSs, actual attack traffic may not be larger than normal traffic, and when the attack is detected by using only the amount of traffic, even normal traffic may be detected as the attack.

In order to overcome this limit, therefore, in the embodiments of the present invention, DNS queries transmitted from the zombie PCs to the local DNSs and DNS query behaviors of general users are modeled to detect the attack. At this time, the DNS protocol is operated as a user datagram protocol (UDP), and in this case, a DNS query may easily be created by changing a source IP address, so the attack traffic transferred from the zombie PCs to the local DNSs may not be analyzed by session.

In order to solve such problem, in the embodiments of the present invention, it is assumed that a list of authenticated IP addresses used in a corresponding management network is known in advance. Thus, it is also assumed that a DNS query having a modified IP address is eliminated in advance before it reaches a local DNS. Based on these assumptions, the embodiment of the present invention will be described.

Now, the embodiments of the present invention will be described in detail with reference to the accompanying drawings which form a part hereof.

FIG. 3 is a block diagram illustrating an apparatus for monitoring and processing DNS query traffic to detect a DNS flooding attack, in accordance with an embodiment of the present invention. The apparatus 300 for monitoring and processing DNS query traffic includes an information processing thread 310, a time thread 320, a traffic determination thread 330 and an attack protection thread 340.

The time thread 320 and the attack protection thread 340 are generated and operated through a separate process from that of the information processing thread 310.

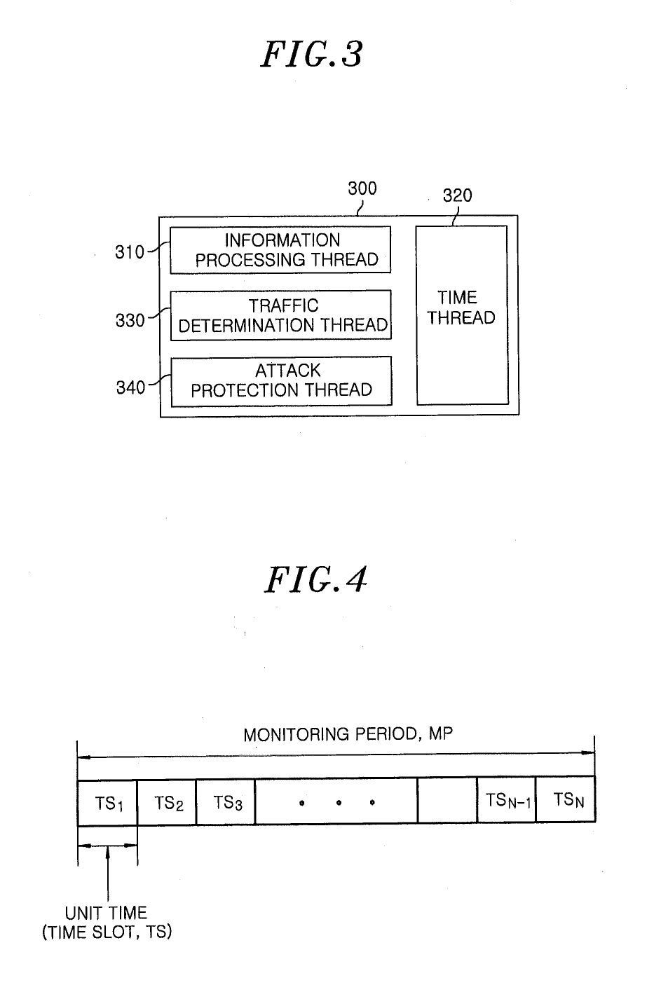

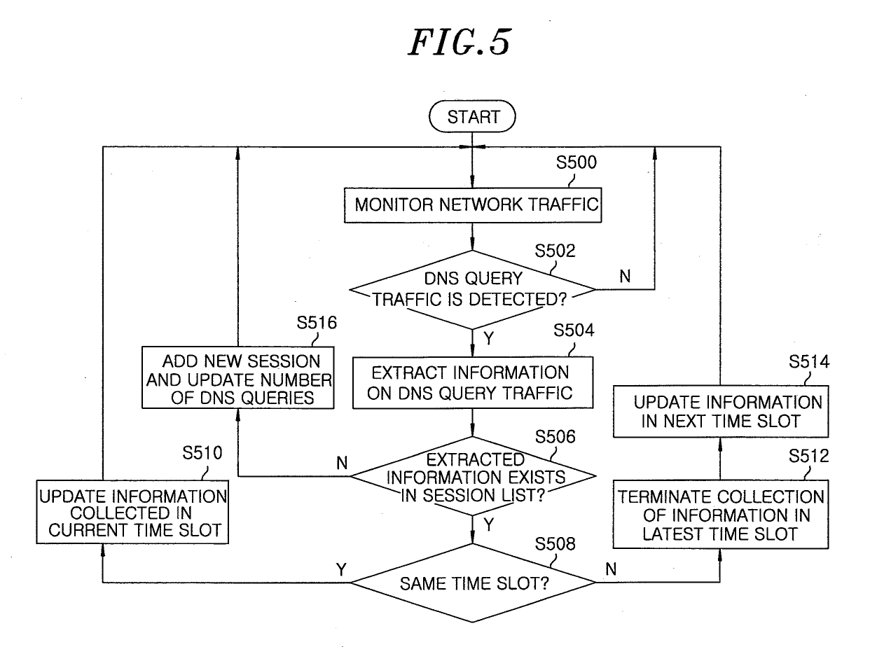

The information processing thread 310 has a set monitoring period (MP) as shown in FIG. 4. The monitoring period is composed of a total of N number of unit times, i.e., time slots (TSs). Here, a period of the time slots may be defined depending on a type of traffic in a normal situation, and, for example, a general DNS protocol may be about 100 ms.

Based on the monitoring period and the time slots, the information processing thread 310 collects various types of information regarding DNS query traffic generated during a corresponding time slot to model the DNS query traffic. Here, the collected information may be calculated on a basis of local DNS.

The information collected during the time slot may include the number of DNS queries requested during the time slot, a variation of the number of the DNS queries requested during the time slot, a byte distribution with respect to URLs of the DNS queries requested during the time slot, an entropy value of the byte distribution with respect to the URLs of the DNS queries requested during the time slot, and the like.

Further, the information processing thread 310 extracts information during the monitoring period based on the information collected in each time slot, wherein the information extracted during the monitoring period may include the number of time slots in which the DNS queries were present during the overall monitoring period, the number of time slots in which the DNS queries were not present during the overall monitoring period, a maximum number of time slots in which the DNS queries were continuously present during the overall monitoring period, a maximum number of time slots in which the DNS queries were not continuously present during the overall monitoring period, a total number of DNS queries extracted in each time slot during the overall monitoring period, a variance value of a variation of the number of DNS queries extracted in each time slot during the overall monitoring period, a variance value of entropy values extracted in each time slot during the overall monitoring period, and the like.

The information processing thread 310 transmits the extracted information to the attack protection thread 340, starts to collect information regarding a first time slot depending on the monitoring period, and applies a control signal for driving the time thread 320 to the time thread 320.

The process of the information processing thread 310 collecting information will be described with reference to FIG. 5.

FIG. 5 is a flowchart illustrating the process of collecting information for traffic modeling in accordance with the embodiment of the present invention.

As shown in FIG. 5, while monitoring network traffic in step S500, the information processing thread 310 determines whether or not DNS query traffic is detected in step S502.

When it is determined in step S502 that the DNS query traffic is detected, the information processing thread 310 extracts basic information, e.g., an IP address, or the like, regarding the DNS query traffic in step S504. Next, the information processing thread 310 checks whether or not the extracted basic DNS query information exists in a preset session list in step S506.

When it is checked in step S506 that the extracted basic DNS query information exists in the preset session list, the information processing thread 310 determines whether or not the DNS query traffic has been generated in the same time slot as that of the session list in step S508.

When the DNS query traffic has been generated in the same time slot as the determination result of step S508, the information processing thread 310 updates information collected in a current time slot in step S510. That is, the information processing thread 310 may update the number of DNS queries, a byte distribution with respect to URLs of the DNS queries, and the like, in the current time slot. Further, a total number of DNS queries may be updated. Thereafter, the process returns to step S500 to continuously monitor network traffic.

Meanwhile, when the DNS query traffic has not been generated in the same time slot as the determination result of step S508, the information processing thread 310 terminates collection which has been being performed in the latest time slot in step S512, to thereby stop counting the number of DNS queries in the latest time slot. In other words, the information processing thread 310 finally calculates the number of the DNS queries, a variation, byte distribution value, and an entropy value of the byte distribution, in the latest time slot.

Next, the information processing thread 310 performs updating information in a next time slot by using monitored DNS query traffic in step S514. Specifically, the information processing thread 310 updates the number of DNS queries, a byte distribution in the next time slot. Further, a total number of DNS queries may be updated. Thereafter, the process returns to step S500. Meanwhile, when it is checked in step S506 that the extracted basic DNS query information does not exist in the preset session list, the information processing thread 310 adds a new session to a session list based on the extracted basic DNS query information and updates the number of DNS queries in step S516. Thereafter, the process returns to step S500.

The time thread 320 serves to check whether or not a monitoring period of a particular session has terminated. When the monitoring period of a particular session terminates, the terminated session information may be inserted into a predefined queue and processed.

The traffic determination thread 330 determines whether or not generated traffic is normal traffic or attack traffic, based on the information collected by the information processing thread 310.

The process of determining traffic by the traffic determination thread 330 will be described as follows.

First, when a general user requests information regarding a particular URL, the user works with an application program which requested a check of the corresponding URL, e.g., with a web browser, an FTP client or the like, during more than a certain time after obtaining the address of the corresponding URL. Thus, a DNS query is not additionally requested within a very short time. With such characteristics considered, it can be determined whether or not a query is a DNS query for an attack or a normal DNS query.

Information extracted by the information processing thread 310 may be expressed in a form of vector and applied to various types of mechanical learning and pattern classification algorithms widely used in information communication research, and accordingly, a threshold interval of learned information is determined. Based on the learning results so performed, data collected by continuously monitoring actual traffic is classified by using a corresponding pattern classification algorithm, thus determining whether or not the traffic is attack traffic. The pattern classification algorithm which is available in this case encompasses every classification scheme, such as a support vector machine, a k-means algorithm, a k-nearest neighbor (k-NN) algorithm, an euclidean distance algorithm, a Bayes' theorem, and the like, which are generally widely used in the field of the information communication research.

Accordingly, when the traffic determination thread 330 determines traffic as an attack, the attack can be blocked by using the attack protection thread 340.

The attack protection thread 340 extracts an attacker IP from the attack traffic and blocks it.

Meanwhile, some DDoS attacks may employ an IP spoofing scheme of attempting an attack by manipulating an IP address. In this respect, however, in the embodiment of the present invention, it is assumed that the list of authenticated IP addresses is known in advance, so the IP spoofing scheme cannot be applied in the DDoS attack. Thus, every source IP address used in the DNS flooding attack in a situation applicable to the present invention can be considered to be an authenticated IP address, so a source IP address derived by the results of traffic analysis is inevitably an IP address of an attacker.

As described above, only attack traffic can be selectively blocked by directly finding out an IP address of a particular attacker in the embodiment of the present invention. Further, effectiveness of the present invention can be maximized by providing a list of target systems to be blocked, by interworking with existing general network security equipments, e.g., IPS, IDS, Firewall, and the like, rather than a product developed by using the present invention. Thus, the present invention can provide an environment in which attack traffic can be blocked and an authenticated user can be continuously provided with a service.

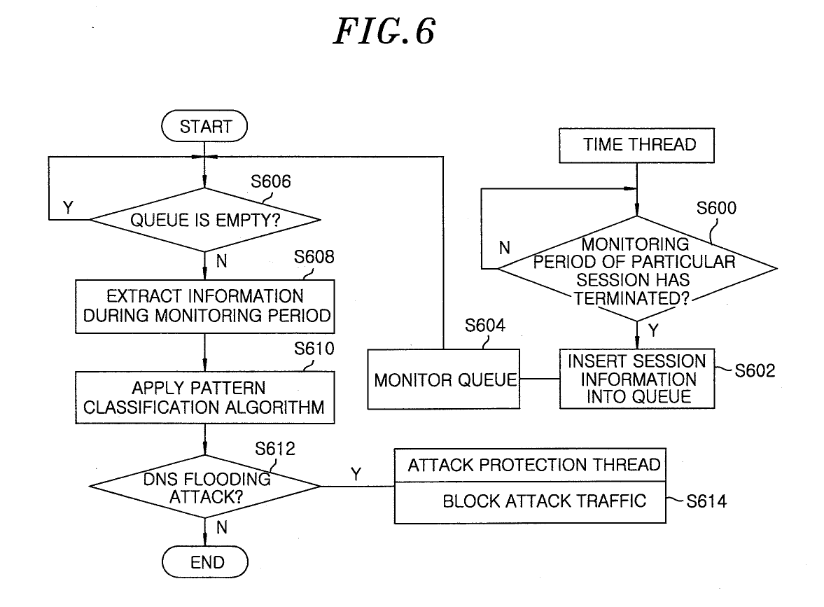

FIG. 6 is a flowchart illustrating the operation process of the apparatus for monitoring and processing DNS query traffic in accordance with the embodiment of the present invention.

As shown in FIG. 6, first, the time thread 320 checks whether or not a monitoring period of a particular session has terminated in step S600. When the monitoring period has terminated, the time thread 320 inserts the terminated session information into a predefined queue so as to be processed in step S602.

Meanwhile, the information processing thread 310 monitors the queue in step S604 to check whether or not the queue is empty in step S606.

When it is checked in step S606 that the queue is not empty, the information processing thread 310 extracts information during the monitoring period based on the information collected in each time slot in step S608. Specifically, the information processing thread 310 may extract the number of time slots in which the DNS queries were present during the overall monitoring period, the number of time slots in which the DNS queries were not present during the overall monitoring period, a maximum number of time slots in which the DNS queries were continuously present during the overall monitoring period, a maximum number of time slots in which the DNS queries were not continuously present during the overall monitoring period, a total number of DNS queries extracted in each time slot during the overall monitoring period, a variance value of a variation of the number of DNS queries extracted in each time slot during the overall monitoring period, a variance value of entropy values extracted in each time slot during the overall monitoring period, and the like.

The thusly extracted information is provided to the traffic determination thread 330. Then, the traffic determination thread 330 applies the information received from the information processing thread 310 to a pattern classification algorithm in step S610 to determine whether or not traffic of the particular session is attack traffic in step S612.

When it is determined in step S612 that the traffic of the particular session is attack traffic, the attack protection thread 340 blocks an IP address of the attack traffic, or drops a packet generated from the IP address of the attack traffic to block the attack traffic in step S614. The attack protection thread 340 may be implemented in a legacy network security device, e.g., a router, a switch, or the like.

In accordance with the embodiment of the present invention as described above, DNS query traffic models in both of normal situation and attack situation are generated, based on which an attack is detected. Thus, although attack traffic is not so much compared with that of the normal situation, the attack traffic can be detected as an attack, and a DNS query concentration phenomenon of the form of flash cloud generated in the normal situation can be determined to be normal, rather than as an attack. Accordingly, an attack detection rate can be increased and an erroneous detection rate can be significantly reduced.

While the invention has been shown and described with respect to the embodiments, it will be understood by those skilled in the art that various changes and modification may be made without departing from the scope of the invention as defined in the following claims.

What is claimed is:

1. A method for monitoring and processing domain name system (DNS) query traffic, the method comprising:
monitoring DNS query traffic in each time slot during a monitoring period comprised of n number of time slots;
extracting traffic information during the monitoring period by using the DNS query traffic monitored in said each time slot; and
analyzing the extracted traffic information to detect a DNS traffic flooding attack.

2. The method of claim 1, wherein, in said monitoring the DNS query traffic, information is collected in said each time slot, the information including the number of DNS queries generated per time slot, a variation of the number of the DNS queries per time slot, a byte distribution with respect to uniform resource locators (URLs) of the DNS queries per time slot, and/or an entropy value of the byte distribution per time slot.

3. The method of claim 2, wherein said monitoring DNS query traffic includes:
checking whether or not the DNS query traffic exists in a preset session list;
determining, when the DNS query traffic exists in the session list, whether or not a corresponding traffic of the session list and the DNS query traffic have been generated in the same time slot;
updating, when the corresponding traffic of the session list and the DNS query traffic have been generated in the same time slot, information collected in a current time slot; and
updating, when the corresponding traffic of the session list and the DNS query traffic have not been generated in the same time slot, information regarding a next time slot.

4. The method of claim 3, wherein, the information collected in the current time slot includes the number of DNS queries in the current time slot and a byte distribution with respect to URLs of the DNS queries in the current time slot.

5. The method of claim 3, wherein said updating information regarding the next time slot includes:
calculating the number of DNS queries requested during the current time slot, a variation of the number of the DNS queries, a byte distribution with respect to the URLs of the DNS queries, and/or an entropy value of the byte distribution with respect to the DNS queries; and
updating the number of the DNS queries in the next time snot and/or a byte distribution with respect to the URLs of the DNS queries in the next time slot.

6. The method of claim 1, wherein, the traffic information extracted during the monitoring period includes: the number of time slots in which DNS queries were present during the monitoring period; the number of time slots in which the DNS queries were not present during the monitoring period; a maximum number of time slots in which the DNS queries were continuously present during the monitoring period; a maximum number of time slots in which the DNS queries were not continuously present during the monitoring period; a total number of DNS queries extracted in each time slot during the monitoring period; a variance value of a variation of the number of DNS queries extracted in each time slot during the monitoring period; and a variance value of entropy values extracted in each time slot during the monitoring period.

7. The method of claim 1, wherein, in said detecting the DNS traffic flooding attack, an IP address of the DNS traffic flooding attacker is detected.

8. An apparatus for monitoring and processing domain name system (DNS) query traffic, the apparatus comprising:
an information processing thread for monitoring DNS queries during a monitoring period comprised of multiple time slots to collect information;
a time thread for informing that the monitoring period has terminated;
a traffic determination thread for determining whether or not DNS query traffic is attack traffic based on the information collected by the information processing thread when the monitoring period has terminated; and
an attack protection thread for blocking the attack traffic determined by the traffic determination thread.

9. The apparatus of claim 8, wherein the information collected by the information processing thread includes the number of DNS queries generated per time slot, a variation of the number of the DNS queries per time slot, a byte distribution with respect to uniform resource locators (URLs) of the DNS queries per time slot, and/or an entropy value of the byte distribution per time slot.

10. The apparatus of claim 8, wherein the information processing thread extracts traffic information during the monitoring period, the traffic information including: the number of time slots in which DNS queries were present during the monitoring period; the number of time slots in which the DNS queries were not present during the monitoring period; a maximum number of time slots in which the DNS queries were continuously present during the monitoring period; a maximum number of time slots in which the DNS queries were not continuously present during the monitoring period; a total number of DNS queries extracted in each time slot during the monitoring period; a variance value of a variation of the number of DNS queries extracted in each time slot during the monitoring period; and a variance value of entropy values extracted in each time slot during the monitoring period.

11. The apparatus of claim 8, wherein when the monitoring period has terminated, the time thread inserts information regarding the DNS query into a predefined queue.

12. The apparatus of claim 8, wherein the traffic determination thread extracts address information of the attack traffic based on the information collected by the information processing thread, and provides the extracted address information to the attack protection thread.

13. The apparatus of claim 8, wherein the traffic determination thread determines whether or not the DNS query traffic is attack traffic by using a pattern classification algorithm such as a support vector machine, a k-means algorithm, a k-nearest neighbor algorithm, an euclidean distance algorithm and a Bayes' theorem.

14. The apparatus of claim 8, wherein the attack protection thread is applied to a network security device.

15. The apparatus of claim 8, wherein the apparatus is installed between a local DNS and a terminal generating the DNS queries.
